(19) United States
(12) Patent Application Publication
(10) Pub. No.: US 2008/0125056 A1
(43) Pub. Date: May 29, 2008

(54) SCHEDULING DEVICE, SCHEDULING METHOD AND HOST DEVICE

(75) Inventors: Makoto Satoh, Kawasaki (JP); Hiroshi Kariya, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 11/939,563

(22) Filed: Nov. 14, 2007

(30) Foreign Application Priority Data
Nov. 29, 2006 (JP) 2006-321711

(51) Int. Cl. H04B 1/00

(52) U.S. Cl. 455/69

(57) ABSTRACT

In a WUSB system having a host device and devices being connected, a scheduling unit included in the host device for scheduling a data transmission of the device outputs resume request transmission control information at an output interval specified by a control unit, where the resume request transmission control information enables a device in abort of data transmission to send a data transmission resume request, excludes a device from a scheduling target in response to an abort request from the device in process of data transmission and resumes to schedule for the device in response to a data transmission resume request transmitted by the device in abort of data transmission responding to the transmission request control information. The control unit specifies the output interval of the resume request transmission control information by the scheduling unit according to an existence of a device in abort of data transmission.

### BACKGROUND OF THE INVENTION

1. Field of the Invention

The present invention relates to scheduling, and particularly to a technique for scheduling a data transmission of a device by a host device.

2. Description of Related Art

In related arts, in a system for transmitting and receiving data, the data transmission of a sending side has been controlled by a reception side of data. For example, as disclosed in Japanese Unexamined Patent Application Publication No. 9-191321, in a wide area network, a credit control is used in which a receiving side notifies a credit to a sending side and the sending side transmits packets for the received credit.

Moreover, in a network of WUSB (Wireless Universal Serial Bus) which is expected to be highlighted as an interface of a personal computer (hereinafter referred to as a PC) because of high-speed data transmission, data transmission is controlled by a host device.

The network topology of WUSB is a hub & spoke type, where devices are connected to the host device (for example, PC) located at the center. The communication between the host device and the devices is point-to-point (PnP) in which a connection is set up in 1 to 1. The devices are for example a printer, a hard disk, a mouse, a digital camera, a game machine and PDA.

In a WUSB cluster (hereinafter merely referred to as a cluster) formed of a host device and devices connected according to WUSB standard, the host device manages the cluster (including the devices in the cluster) using MMC (Micro-scheduled Management Command). As shown in FIG. 5, MMC is sent from the host device at the predetermined interval A. The MMC includes identification information of the host device and transmission time of the next MMC or the like.

In the WUSB system, device-oriented connection association where an action is started from a device is adopted for connections. The host device notifies to the devices in the cluster by sending host identification information or the like via MMC. In addition, in this MMC, start time information (WdntsCTA, W: Wireless USB, CTA: Channel Time Allocation) of DNTS (Device Notification Time Slot) is also included, which is configured so that the device can issue a connection request to the host device. DNTS is a slot prepared in order for individual devices to send a small asynchronous information message to a host device, and a plurality of DNTS are prepared. The device retrieves and holds host identification information at the time of configuring the cluster it belongs, which enables to evaluate whether it is the host device of the cluster that the device belongs based on the host identification information included in the MMC from the host device. When issuing a connection request to the host device of the cluster that the device belongs, a slot sent from the prepared slots is randomly selected to issue a connection request. After that, the host device and the device perform mutual authentication by a handshake and complete the connection. FIG. 5 shows the transmit timing of MMC and WdntsCTA. As shown in FIG. 5, WdntsCTA is sent via MMC, however the transmission interval B is different from the transmission interval A of MMC and is longer than the transmission interval A.

On the other hand, in the WUSB system, in a data transmission between the host device and the devices in the cluster, the host device is in control. As shown in FIG. 6, to the plurality of devices for performing data transmission with the host device, the host device allocates a band (time band) for each of the devices to transmit and receive data (hereinafter also referred to as scheduling) and at the same time, the host device transmits Wdr/dtCTA (Wireless USB Allocation Block, dr: reception dt: transmission. Hereinafter referred to as WxCTA including transmission and reception) indicating the band via MMC. The device receives the WxCTA and transmits and receives in the band secured by the WxCTA for the device.

WdntsCTA transmitted by the host device is used also in order for the device in process of data transmission to request to resume data transmission, other than being used for the device to send a connection request. This is explained in detail with reference to FIG. 7.

As shown in FIG. 7, the device transmits and receives data with the host device according to WdntsCTA transmitted from the host device. One device sends a NAK (Negative Acknowledgement) response to WxCTA for preparing data to be transmitted next, for example, and stops the data transmission temporarily. In response to the NAK response, the host device excludes the device which sent the NAK response from scheduling target. The state of the device is hereinafter referred to as “under flow control.”

The host device excludes the device which sent the NAK response from the scheduling target. At this time, if there is another device in process of data transmission, the host device continues to schedule for the device and send WxCTA. For the clarity of the explanation, FIG. 7 shows WxCTA only for the device which sent the NAK response. As illustrated, for the device which sent the NAK response, WxCTA intended for this device is not transmitted from the host device.

In order to resume data transmission after completing to prepare the data, the device under flow control requests to resume the data transmission by transmitting EPReady to the host device. In response to EPReady from the device, the host device includes this device to be scheduling target and transmits WxCTA for the device again.

In a WUSB system, the EPReady can be transmitted by a device only in a band secured by WdntsCTA as a device notification. On the other hand, the transmission interval of WdntsCTA is set by a driver of a host device and is usually being fixed to several msec. Therefore, as shown in FIG. 7, the device under flow control needs to wait for WdntsCTA in order to transmit EPReady, even though the data preparation has been completed. I have now discovered that the longer the waiting time, there is a problem that resumption of the data transmission for the device under flow control is delayed and data transmission becomes inefficient.

### SUMMARY

In one embodiment, a scheduling device includes a scheduling unit to schedule a data transmission for a device in process of data transmission with a host device, where the host device being connectable with a plurality of the devices and a control unit to control the scheduling unit. The scheduling unit outputs resume request transmission control information at an output interval specified by the control unit, where the resume request transmission control information enables a device in abort of data transmission to send a data transmission resume request and in response to an abort request from a device in process of data transmission, the scheduling unit excludes the device from scheduling target. Moreover, the scheduling unit resumes to schedule a data transmission in response to the data transmission resume request transmitted from a device in abort of data transmission responding to the resume request transmission control information. The control unit sets the output interval of the resume request transmission control information by the scheduling unit according to an existence of a device in abort of data transmission.

In another embodiment, a method of scheduling includes scheduling a data transmission for a device in process of data transmission with a host device, where the host device being connectable with a plurality of the devices, outputting resume request transmission control information at an output interval specified by the control unit, where the resume request transmission control information enables a device in abort of data transmission to send a data transmission resume request, excluding a device from a scheduling target in response to an abort request from the device in process of transmission, resuming to schedule a data transmission in response to the data transmission resume request transmitted from a device in abort of data transmission responding to the resumption request transmission control information. This method sets an output interval of the resumption request transmission control information according to an existence of a device in abort of data transmission.

In another embodiment, a host device includes the abovementioned scheduling device.

Note that a system and a program representing the above embodiments are also effective as aspects of the present invention.

The technique of the present invention enables to resume the data transmission of the device under flow control faster and improve the efficiency of data transmission.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a WUSB system 100 according to an embodiment of the present invention;

FIG. 2 shows a host device in the WUSB system shown in FIG. 1;

FIG. 3 is a flowchart showing the process of a control unit in the host device shown in FIG. 2;

FIG. 4 shows an example of scheduling by a scheduling unit in the host device shown in FIG. 2;

FIG. 5 explains a transmission interval of WdntsCTA in a WUSB system;

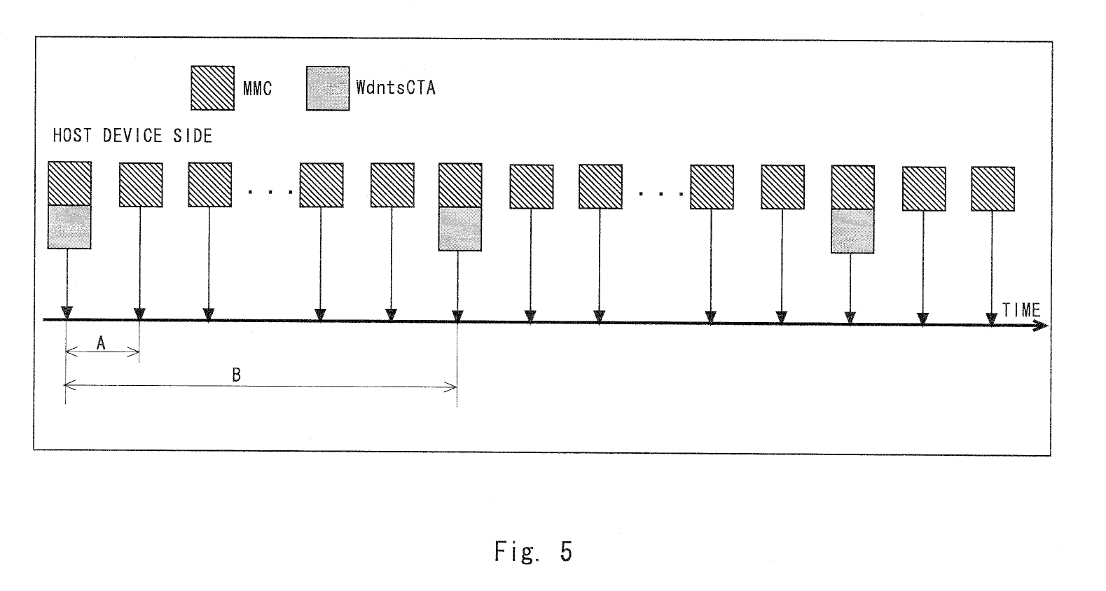

FIG. 6 explains scheduling of a data transmission in a WUSB system; and

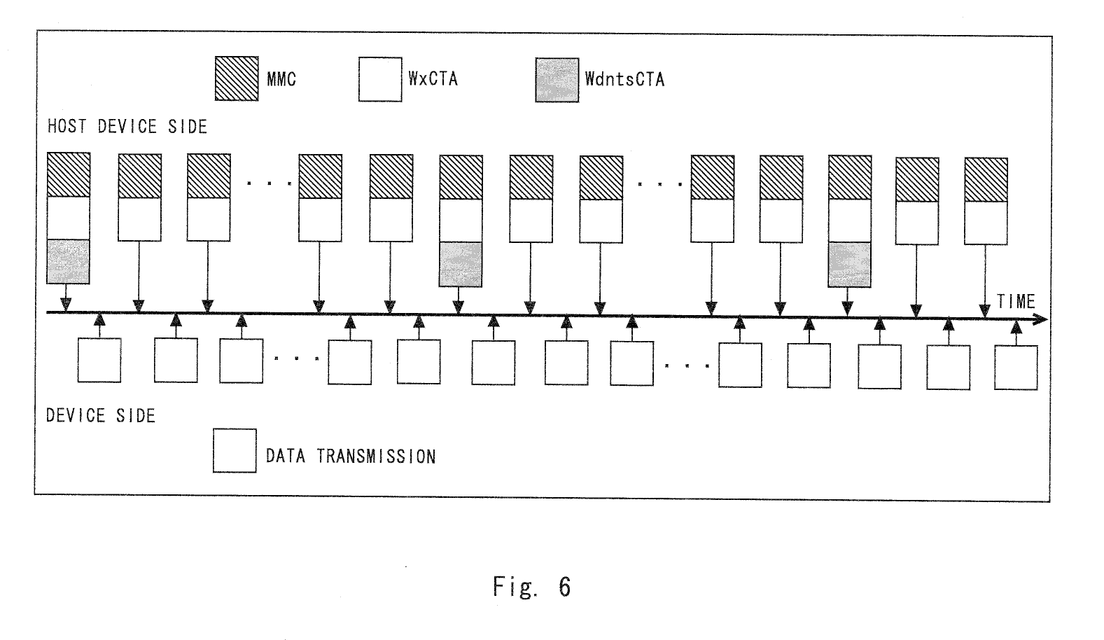

FIG. 7 shows a timing for data transmission resumption of a device of flow control in a WUSB system according to a prior art.

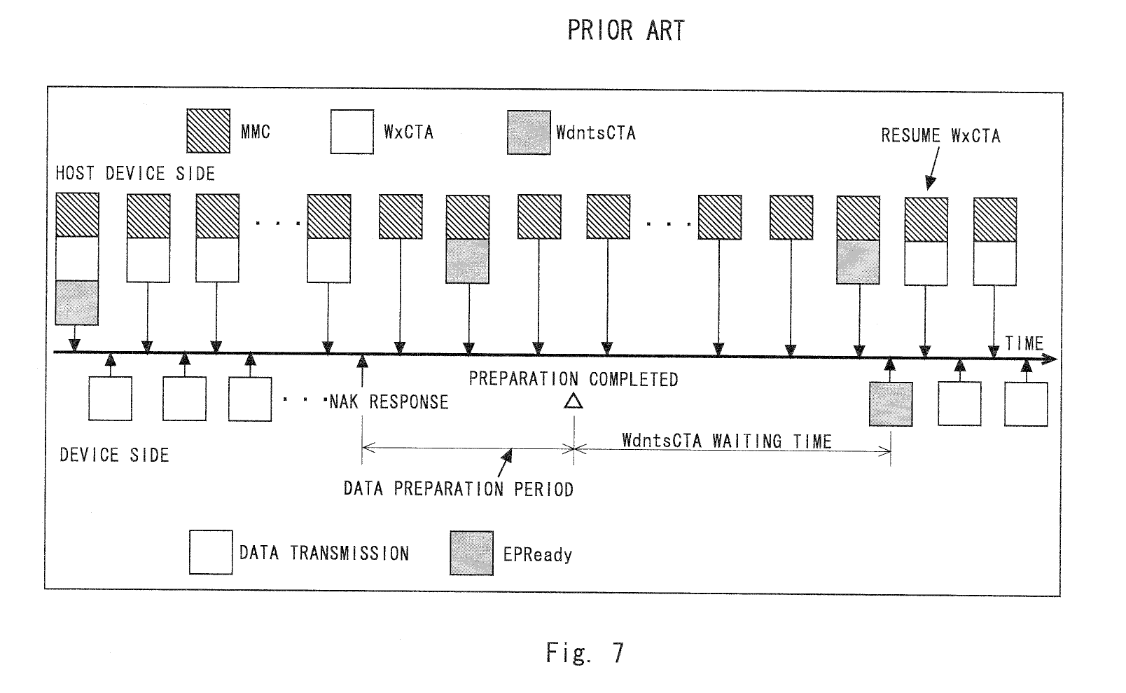

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

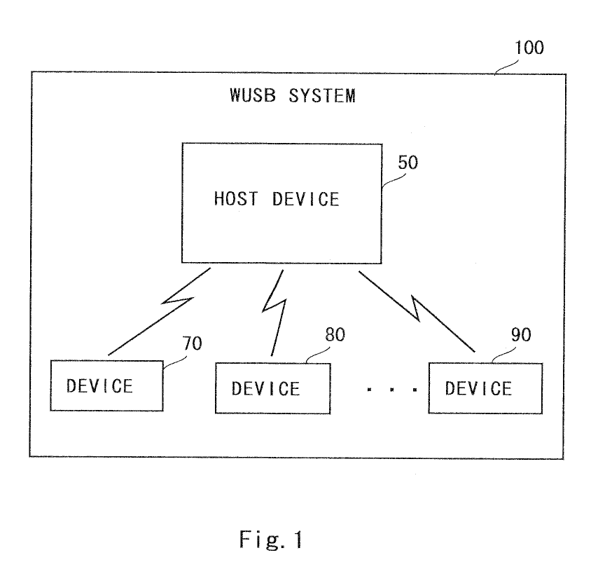

FIG. 1 shows a WUSB system 100 according to an embodiment of the present invention. The WUSB system 100 includes a host device 50 and a plurality of WUSB devices (3 in the example of FIG. 1; a device 70, a device 80 and a device 90).

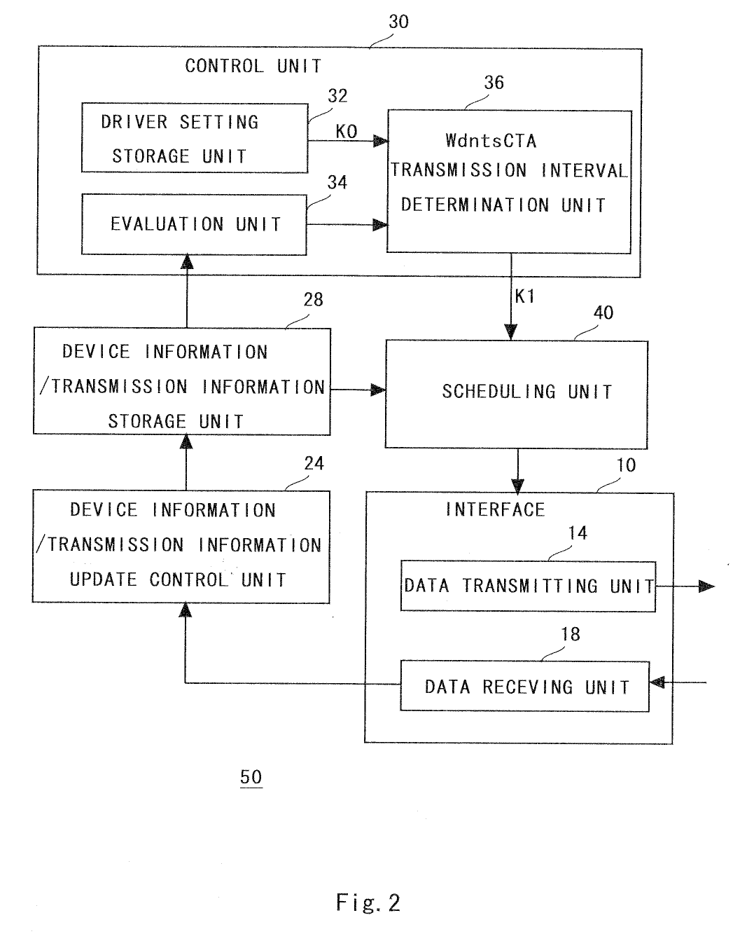

The host device 50 is a PC, for example, and FIG. 2 shows the configuration thereof. Note that to clarify the main point of the present invention, only the portions responsible for processes concerning the present invention are explained and illustrated hereinbelow.

As shown in FIG. 2, the host device 50 includes an interface 10, a device information/transmission information update control unit (hereinafter merely referred to as an update control unit) 24, a device information/transmission information storage unit (hereinafter merely referred to as a storage unit) 28, a control unit 30 and a scheduling unit 40. Note that each component illustrated in the drawings as functional blocks to perform various processes of the host device 50 can be constituted from CPU, memory and other LSI in terms of hardware and in terms of software, they can be realized by programs loaded to a memory or the like. Therefore, those skilled in the art will understand that these functional blocks can be realized in various forms, only with hardware, software or the combination of them and it is not limited to either.

The interface 10 conforms to the WUSB standard. Connections between the host device 50 and each device and data transmissions are performed via the interface 10. The interface 10 has the data transmitting unit 14 for transmitting from the host device 50 to the devices and a receiving unit 18 for receiving a response and data from the devices.

The storage unit 28 stores device information and transmission information. Device information includes identification information and types of the device in connection (the types of the device are described later) and information indicating the state of the device such as whether the device is in data transmission or under flow control. Transmission information includes remaining data length of transmission data, the number of errors generated during data transmission and memory address information of the transmission data storage destination.

The update control unit 24 updates contents stored in the storage unit 28 according to a response sent by the device via the data receiving unit 18 and data transmitted by the device.

The scheduling unit 40 performs scheduling of the communication from the device to the host device 50. These communications include data transmission between the devices and the host device 50 and transmission of notification from the devices such as a response or a request from the devices to the host device 50.

As for data transmission, the scheduling unit 40 schedules data transmission of the device by transmitting WxCTA via MMC. In this WxCTA, information specifying whether it is a reception or a transmission, information specifying a device to receive/transmit and a time slot (band) of a reception or a transmission etc. The device carries out an operation (reception or transmission) specified by the time slot assigned for the device according to WxCTA. Note that in the following explanation, “a device in operation connected to the host device 50” is referred to as “an active device.”

As for a notification from the device, the scheduling unit 40 schedules by transmitting WdntsCTA via MMC. This WdntsCTA is transmitted in a broadcast to all the devices in a cluster. The device attempting to transmit a notification transmits a notification in the band specified by this WdntsCTA.

An active device may send a NAK response in order to prepare data and go under flow control. The scheduling unit 40 excludes the device which sent a NAK response from scheduling target of data transmission. If data preparation is completed, the device under flow control requests to resume a data transmission by transmitting a notification to be EPReady in the band specified by WdntsCTA transmitted from the scheduling unit 40. In response to the EPReady from the device under flow control, the scheduling unit 40 includes this device as the scheduling target of data transmission again and secures the band for the data transmission of this device by WxCTA.

Since EPReady cannot be transmitted unless receiving WdntsCTA, even if the device under control completed the preparation of data, the shorter the interval of WdntsCTA, the faster the data transmission resumes.

In the WUSB system 100 of this embodiment, the transmission interval K1 of WdntsCTA by the scheduling unit 40 is controlled by the control unit 30. As shown in FIG. 2, the control unit 30 includes a driver setting storage unit 32, an evaluation unit 34 and a WdntsCTA transmission interval determination unit 36.

The driver setting storage unit 32 stores the transmission interval K0 (usually several msec) of WdntsCTA configured by the WUSB of the host device 50. According to the evaluation result by the evaluation unit 34, the WdntsCTA transmission interval determination unit 36 determines whether to leave the transmission interval K1 of WdntsCTA by the scheduling unit 40 as the transmission interval K0 of WdntsCTA stored by the driver setting storage unit 32 or to make the transmission interval K to a changed value.

Here, before explaining the details of the evaluation unit 34 of the control unit 30 and WdntsCTA transmission interval determination unit 36, the relationship between WdntsCTA and WxCTA is considered based on the types of device. In data transmission, a WUSB device is broadly divided into a periodic device and an asynchronous device.

The periodic device does not need to be allocated many bands for data transmission, however must be certainly allocated a band periodically. As an example of the periodic device, there are human interfaces such as a mouse and a keyboard.

On the contrary to the periodic device, the asynchronous device does not require periodicity of the band allocated but requires many bands. As an example of the asynchronous device, there are storage devices such as a hard disk.

As mentioned above, WxCTA specifies a band for a device which carries out a data transmission, and WdntsCTA specifies a band for a device to transmit a notification. Therefore, if the frequency of WdntsCTA is high, the bands secured by WdntsCTA in order for a device to transmit a notification will increase, and the bands can be used by WxCTA will decrease relatively. Therefore, if the frequency of WdntsCTA is made high when there is an asynchronous device which requires many bands among the devices in process of data transmission, the bands allocated to the asynchronous device will decrease, thereby deteriorating the efficiency of data transmission.

On the other hand, since a periodic device should just be allocated bands periodically and does not require a volume of bands, even if the frequency of WdntsCTA is made high, there is little influence on data transmission of the periodic device.

It is needless to say that regardless of the types, if there is no device in process of data transmission, there is no influence on data transmission even if the frequency of WdntsCTA is made high.

The evaluation unit 34 of the control unit 30 in the host device 50 evaluates for the WdntsCTA transmission interval determination unit to set the transmission interval of WdntsCTA transmitted by the scheduling unit 40. More specifically, the evaluation unit 34 evaluates the existence of the device under flow control and existence and magnitude of influence on data transmission of a device in process of data transmission when the transmission interval of WdntsCTA is shortened. The existence of the device under flow control is evaluated based on the device information stored in the storage unit 28. As for the existence and the magnitude of influence, for example when all the devices in connection are under flow control (meaning that there is no device in process of data transmission), the evaluation unit 34 evaluates as “no influence”. When all the devices in process of data transmission are periodic devices, it evaluates as “influece:small”. Moreover, when there is an asynchronous devices among the devices in process of data transmission, the evaluation unit 34 evaluates as “influence:large”. Note that the state of an active device (whether the device is under flow control or not) and the types thereof are stored in the storage unit 28.

In response to such evaluation result by the device evaluation unit 34, in case of “influence:large”, the WdntsCTA transmission interval determination unit 36 leaves the transmission interval K1 of WdntsCTA by the scheduling unit 40 as the transmission interval K0. In case of “no influence” and “influence: small”, the WdntsCTA transmission interval determination unit 36 changes the transmission interval K1 of WdntsCTA by the scheduling unit 40 to a smaller value than the transmission interval K0 and outputs to the scheduling unit 40.

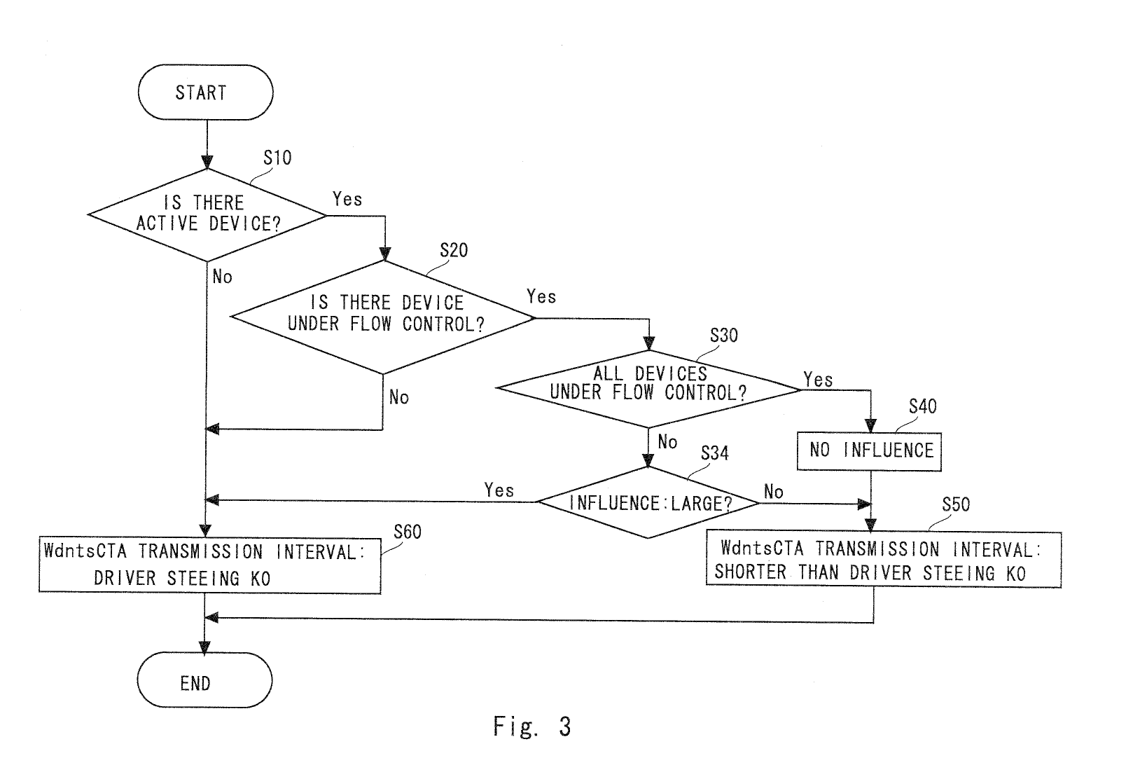

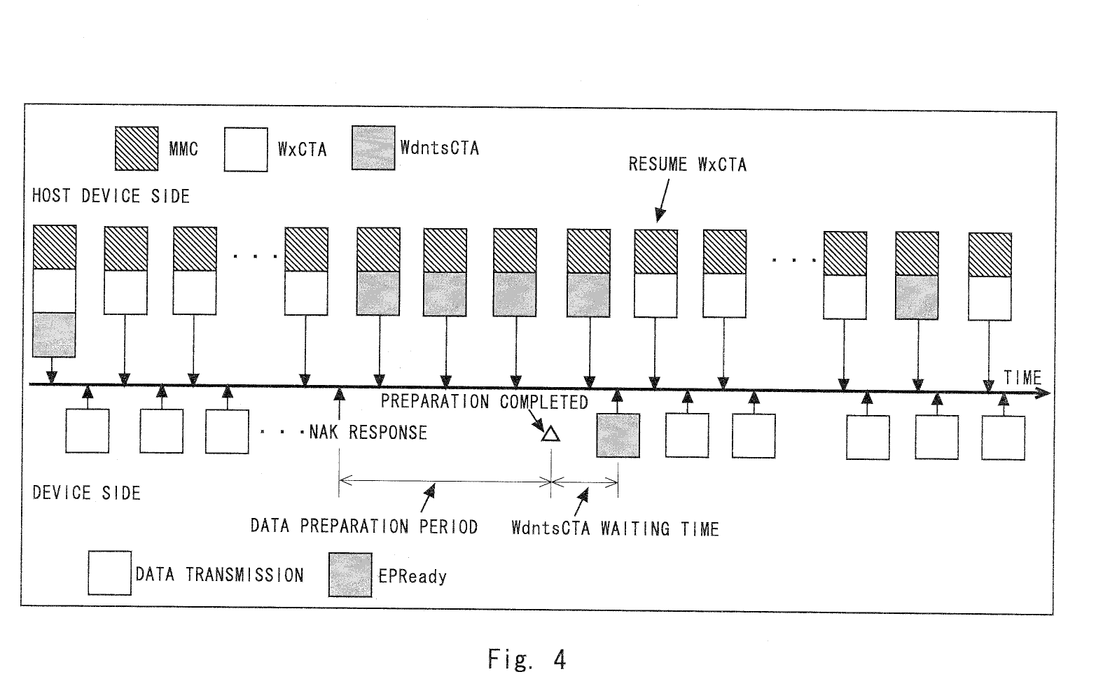

The processes of the control unit 30 and the scheduling unit 40 are explained in more detail here with reference to FIGS. 3 and 4.

FIG. 3 is a flowchart showing the process by the control unit 30. In the control unit 30, the WdntsCTA transmission interval determination unit 36 determines the transmission interval K1 of WdntsCTA transmitted by the scheduling unit 40 according to the evaluation result of the evaluation unit 34.

More specifically, firstly the evaluation unit 34 checks the existence of an active device (S10). If there is no active device, the WdntsCTA transmission interval determination unit 36 sets the transmitting interval K1 to the transmission interval K0 stored in the driver setting storage unit 32 (S10:No, S60). Meanwhile, if there are active devices, the evaluation unit 34 further checks the existence of a device under flow control among these devices (S10:Yes, S20).

If there is no device under flow control, the WdntsCTA transmission interval determination unit 36 sets the transmission interval K1 to the transmission interval K0 stored by the driver setting storage unit 32 (S20:N0, S60). On the other hand, if there is a device under flow control, the WdntsCTA transmission interval determination unit 36 further checks the existence of the device in process of data transmission (S20:Yes, S30).

If there is no device in process of data transmission, meaning that all active devices are under control, the WdntsCTA transmission interval determination unit 36 takes as “no” influence by shortening the transmission interval of WdntsCTA and changes it to a smaller value than the transmission interval K0 in the driver setting (S30:Yes, S50).

On the other hand, if there is a device in process of data transmission, the WdntsCTA transmission interval determination unit 36 checks the magnitude of influence on data transmission by such device from shortening the transmission interval of WdntsCTA (S30:No, S34). In this embodiment, the WdntsCTA transmission interval determination unit 36 checks the magnitude of the influence based on the types of the device in process of data transmission. More specifically, if there is an asynchronous device which requires many bands included in the devices in process of data transmission, the WdntsCTA transmission interval determination unit 36 takes it as “influence: large” and sets the transmission interval K1 to the transmission interval K0 stored in the driver setting storage unit 32 (S34:Yes, S60). On the other hand, if there are only periodic devices and no asynchronous device included in the devices in process of data transmission, the WdntsCTA transmission interval determination unit 36 takes it as “influence: small” and changes the transmission interval K1 of WdntsCTA to a value smaller than the transmission interval K0 in the driver setting (S34:No, S50).

The scheduling unit 40 transmits WdntsCTA at the transmission interval K1 set by the WdntsCTA transmission interval determination unit 36. FIG. 4 shows scheduling operation of the scheduling unit 40 under the control by the control unit 30 mentioned above.

In default state, the transmission interval K1 of WdntsCTA shall be set to the transmission interval K0 in the driver setting. As shown in the anterior portion of FIG. 4, the device in process of data transmission performs data transmission with the host device 50 in the band specified for the device according to WxCTA output from the scheduling unit 40 of the host device 50. Note that the anterior portion of FIG. 4 is the case where there is no device in flow control. In this case, WdntsCTA is transmitted with the default value, which is the transmission interval K0 in the driver setting.

As shown in the middle portion of FIG. 4, suppose that a certain device in process of data transmission sent a NAK response to the host device 50 for data preparation. The scheduling unit 40 of the host device 50 which received the NAK response excludes this device from the scheduling target and in WxCTA sent subsequently, there is no specification of the band for this device. Note that in FIG. 4, for the clarity of explanation, the scheduling unit 40 is not outputting WxCTA after the device sent the NAK response. However this is only to show that the device which sent the NAK response is excluded from the scheduling target and if there is a device in process of data transmission, the scheduling unit 40 outputs WxCTA for scheduling data transmission for the device.

The device which sent the NAK response enters a flow control period for preparing data. At this time, the control unit 30 sets the transmission interval K1 of WdntsCTA by the process shown in FIG. 3. FIG. 4 shows the case where the transmission interval K1 of WdntsCTA is set to a value smaller than K0 of the driver setting value (in the example of FIG. 4, the same interval as MMC) by the control unit 30. By this setting, in the flow control period of the device which sent the NAK response, the transmission frequency of WdntsCTA from the scheduling unit 40 becomes high. Thus when the device which entered the flow control period completed to prepare data, it can receive WdntsCTA faster and transmits EPReady faster. In response to EPReady from a device under flow control, the scheduling unit 40 of the host device 50 includes this device in the scheduling target again. Thus by shortening the transmission interval of WdntsCTA, a data transmission of the device which entered the flow control can be resumed faster and thereby improving the transmission efficiency.

Moreover, when there is no device in process of flow control, by leaving the transmission interval of WdntsCTA as the driver setting, it is possible to prevent unnecessary WdntsCTA from flowing into the system.

Furthermore, even when there is a device under flow control, if influence on data transmission of other devices is large from shortening the transmission interval of WdntsCTA than the driver setting, it is possible to prevent from deteriorating the data transmission efficiency for asynchronous device etc. by changing the transmission interval of WdntsCTA because the transmission interval of WdntsCTA is left as the driver setting.

The present invention was explained based on the embodiment. The embodiment is only illustrative and various change, addition and subtraction may be made without departing from the scope and spirit of the invention. Those skilled in the art will understand that the modifications including such change, addition and subtraction are in the scope of the present invention.

For example, in the WUSB system 100 of this embodiment, the control unit 30 of the host device 50 evaluates the influence on data transmission of other devices from shortening the transmission interval of WdntsCTA into 3 levels; “influence:large”, “influence:small” and “no influence”. However the influence may be evaluated in more levels because the influence increases as the number of asynchronous devices included in the devices in process of data transmission increases, for example. Moreover, also when setting the transmission interval of WdntsCTA, the transmission interval of WdntsCTA may be set so that for smaller level of the influence, the transmission interval of WdntsCTA can be shortened within the range from the driver setting value K0 to MMC, not as in the control unit 30 which sets the transmission interval in 2 ways, whether to leave it as the driver setting or set it to the same interval as MMC.

Moreover, this embodiment is an example of incorporating the technique of the present invention to a WUSB system. The technique of the present invention can be incorporated to any system in which a host device schedules data transmission of a device, a device is excluded from scheduling target for data preparation and in order to issue a resume request to the host device to resume data transmission, the system requires to receive control information that enables to transmit the resume request from the host device.

It is apparent that the present invention is not limited to the above embodiments, but may be modified and changed without departing from the scope and spirit of the invention.

What is claimed is:

1. A scheduling device comprising:
a scheduling unit to schedule a data transmission for a device in process of data transmission with a host device, the host device being connectable with a plurality of the devices; and
a control unit to control the scheduling unit,
wherein the scheduling unit outputs resume request transmission control information at an output interval specified by the control unit, the resume request transmission control information enabling a device in abort of data transmission to send a data transmission resume request,
in response to an abort request from a device in process of data transmission, the scheduling unit excludes the device from scheduling target,
the scheduling unit resumes to schedule a data transmission in response to the data transmission resume request transmitted from a device in abort of data transmission responding to the resume request transmission control information, and
the control unit sets the output interval of the resume request transmission control information by the scheduling unit according to an existence of a device in abort of data transmission.

2. The scheduling device according to claim 1, wherein the control unit sets the output interval in case there is a device in abort of data transmission to the output interval or shorter than a case of having no device in abort of data transmission.

3. The scheduling device according to claim 2, wherein the control unit further checks an existence of a device in process of data transmission in case there is a device in abort of data transmission, and
the control unit sets the output interval in case there is no device in process of data transmission to the output interval or shorter than a case of having a device in process of data transmission.

4. The scheduling device according to claim 3, wherein the control unit, in case there is a device in process of data transmission, further evaluates a magnitude of influence on a data transmission of the device from setting the output interval shorter and sets the output interval shorter as smaller the influence is.

5. The scheduling device according to claim 4, wherein the host device and the devices conform to WUSB (Wireless Universal Serial Bus) standard, and
the control unit evaluates the influence is larger in case an asynchronous device is included than a case of having no asynchronous device among devices in process of transmission.

6. A method of scheduling comprising:
scheduling a data transmission for a device in process of data transmission with a host device, the host device being connectable with a plurality of the devices;
outputting resume request transmission control information at an output interval specified by the control unit, the resume request transmission control information enabling a device in abort of data transmission to send a data transmission resume request;
excluding a device from a scheduling target in response to an abort request from the device in process of transmission;
resuming to schedule a data transmission in response to the data transmission resume request transmitted from a device in abort of data transmission responding to the resumption request transmission control information; and
setting an output interval of the resumption request transmission control information according to an existence of a device in abort of data transmission.

7. The method according to claim 6, wherein the output interval in case there is a device in abort of data transmission to the output interval or shorter than a case of having no device in abort of data transmission.

8. The method according to claim 7, further comprising:
checking an existence of a device in process of transmission in case there is a device in abort of data transmission; and
setting the output interval in case there is no device in process of data transmission to the output interval or shorter than a case of having a device in process of data transmission.

9. The method according to claim 8, further comprising:
evaluating, in case there is a device in process of data transmission, a magnitude of influence on a data transmission of the device from setting the output interval shorter and sets the output interval shorter as smaller the influence is.

10. The scheduling device according to claim 9, further comprising:
evaluating the influence to be larger in case an asynchronous device is included than a case of having no asynchronous device among devices in process of data transmission,
wherein the host device and the devices conform to WUSB (Wireless Universal Serial Bus) standard.

11. A host device connectable with a plurality of devices, comprising:
a scheduling unit to schedule a data transmission for the device in process of data transmission with the host device; and
a control unit to control the scheduling unit,
wherein the scheduling unit outputs resume request transmission control information at an output interval specified by the control unit, the resume request transmission control information enabling a device in abort of data transmission to send a data transmission resume request,
in response to an abort request from a device in process of data transmission, the scheduling unit excludes the device from a scheduling target,
the scheduling unit resumes to schedule a data transmission in response to the data transmission resume request transmitted from a device in abort of data transmission responding to the resume request transmission control information, and
the control unit sets the output interval of the resume request transmission control information by the scheduling unit according to an existence of a device in abort of data transmission.

12. The host device according to claim 11, wherein the control unit sets the output interval in case there is a device in abort of data transmission to the output interval or shorter than a case of having no device in abort of data transmission.

13. The scheduling device according to claim 12, wherein the control unit further checks an existence of a device in process of data transmission in case there is a device in abort of data transmission, and
the control unit sets the output interval in case there is no device in process of data transmission to the output interval or shorter than a case of having a device in process of data transmission.

14. The host device according to claim 13, wherein the control unit, in case there is a device in process of data transmission, further evaluates a magnitude of influence on a data transmission of the device from setting the output interval shorter and sets the output interval shorter as smaller the influence is.

15. The host device according to claim 14, wherein the host device and the devices conform to WUSB (Wireless Universal Serial Bus) standard, and
the host device evaluates the influence to be larger in case an asynchronous device is included than a case of having no asynchronous device among devices in process of data transmission.
